(19) United States
(12) Patent Application Publication
(10) Pub. No.: US 2026/0300069 A1
(43) Pub. Date: Oct. 1, 2026

(54) ANOMALY DETECTION OF ASYNCHRONOUS TRANSACTIONS

(71) Applicant: International Business Machines Corporation, Armonk, NY (US)

(72) Inventors: Bo Chen Zhu, Xi'an (CN); Mai Zeng, Shi Jing Shan (CN); Xiao Chen Huang, BEIJING (CN); Peng Hui Jiang, BEIJING (CN); Min Cheng, BEIJING (CN)

(73) Assignee: International Business Machines Corporation, Armonk, NY (US)

(21) Appl. No.: 19/092,071

(22) Filed: Mar. 27, 2025

(51) Int. Cl. G06F 11/07

(52) U.S. Cl. CPC G06F 11/076; G06F 11/0721

(57) ABSTRACT

An embodiment includes receiving trace data by a receiving interface of an anomaly detection system, the trace data queued in a start node queue and an end node queue. The embodiment includes issuing an instruction via an interface of the anomaly detection system, the instruction executing to provision a data store comprising the start node queue and the end node queue. The embodiment includes executing a modifying instruction modifying a start trace in the start node queue and an end trace in the end node queue to result in a grouped trace for an interval, grouped by a relationship between the start trace and the end trace. The embodiment includes executing a quota metric instruction to determine a quota metric for the interval from the grouped trace based on an uncompleted transaction count, to determine whether an anomaly, comprising a change in the trace data exists in the trace data.

### BACKGROUND

The present invention relates generally to computer error control. More particularly, the present invention relates to a method, system, and computer program for Anomaly Detection of Asynchronous Transactions.

In today's age of digital transformation and cloud-driven application deployments, delivering an excellent digital experience for end-user experience is the primary focus for organizations. Modern distributed services are large, complex, and increasingly built upon other similarly complex distributed services. For example, many search engine services use various internal services (e.g., for ads and spell-checking) that have been deployed atop infrastructure services which are spread across 100s of nodes and built atop other services. Even “simple” web applications generally involve multiple tiers, some of which are scalable and distributed.

Simply tracking computer errors, application up/down status and basic CPU and memory utilization metrics is no longer sufficient. Solutions are needed that offer better tracking and real-time insights to meet the growing demands of modern application monitoring. A cohesive strategy that focuses on customers'digital experience, business transactions, application dependencies and infrastructure performance is key to achieving application performance success.

### SUMMARY

The illustrative embodiments provide for Anomaly Detection of Asynchronous Transactions. An embodiment includes receiving trace data by an input at a receiving interface of an anomaly detection system, wherein the trace data is queued in a start node queue and an end node queue. The embodiment includes issuing a provision instruction via an interface of the anomaly detection system, the provision instruction received by a data store interface, the provision instruction executing to provision a data store comprising the start node queue and the end node queue. The embodiment includes executing a modifying instruction to modify a start trace in the start node queue and an end trace in the end node queue to result in a grouped trace for an interval, the grouped trace grouped by a relationship between the start trace and the end trace. The embodiment also includes executing a quota metric instruction to determine a quota metric for the interval from the grouped trace based on an uncompleted transaction count wherein the quota metric determines whether an anomaly exists in the trace data, the anomaly comprising a change in the trace data.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a diagram of an anomaly monitoring system determining whether an anomaly exists in the trace data in an environment in accordance with an illustrative embodiment;

FIG. 3 depicts a diagram of receiving a start trace in the start node queue and an end trace in the end node queue in an environment in accordance with an illustrative embodiment;

FIG. 4 depicts a diagram of a data structure of a start node queue and an end node queue in a data store in an environment in accordance with an illustrative embodiment;

FIG. 5 depicts a diagram of initializing a start trace in a start node queue and an end trace in an end node queue an environment in accordance with an illustrative embodiment;

FIG. 6 depicts a diagram of determining a quota metric for an interval from the grouped trace in an environment in accordance with an illustrative embodiment;

FIG. 7 depicts a graph of trace trends to detect an anomaly in an environment in accordance with an illustrative embodiment;

FIG. 8 depicts a flow chart of detecting an anomaly by an anomaly detection system in an environment in accordance with an illustrative embodiment; and

FIG. 9 depicts a system diagram of an anomaly detection system to detect an anomaly in an environment in accordance with an illustrative embodiment.

### DETAILED DESCRIPTION

The existing approach for transaction error tracking and control, based on the end-to-end transaction topology generated, comprises using response time analysis for each step or node for the whole transaction to detect the potential abnormal part or an anomaly for the transaction at different levels of the execution pathway. Distributed systems involve two kinds of transactions: synchronous transaction where each sub-transaction or task will wait until there is a response; and asynchronous transaction where some of the sub-transactions or tasks will not wait until the response after the request is sent.

Asynchronous transactions have characteristics which make them more difficult to perform anomaly detection for error tracking and control based on response time detection. For instance, these transactions have different start and end transactions. The start transaction usually issues the starting point of the transaction and ends immediately. Another transaction will be used for the response and the asynchronous part may have no response time. In another instance, asynchronous transactions may be performed taking multiple paths based on different business goals and use cases. For the same start transaction, there will be multiple paths depending on the different business goals and cases. A different path will have different response times. Currently known anomaly detection systems for error tracking and control fail to provide for these characteristics of asynchronous transactions. These current limitations make it impossible to provide efficient, cost-effective and self-aware services, pertaining specifically to anomaly detection for error tracking and control, to end users. As a result, current efforts in this regard are inefficient and ineffective due to the current inability to determine anomaly detection for error tracking and control of asynchronous transactions.

The following description provides examples of embodiments of the present disclosure, and variations and substitutions may be made in other embodiments. Several examples will now be provided to further clarify various aspects of the present disclosure.

Example 1: A computer-implemented method that comprises receiving trace data by an input at a receiving interface of an anomaly detection system, wherein the trace data is queued in a start node queue and an end node queue. The method further comprises issuing a provision instruction via an interface of the anomaly detection system, the provision instruction received by a data store interface, the provision instruction executing to provision a data store comprising the start node queue and the end node queue. The method further comprises executing a modifying instruction to modify a start trace of the start node queue and an end trace of the end node queue to result in a grouped trace for an interval, the grouped trace grouped by a relationship between the start trace and the end trace. The method further comprises executing a quota metric instruction to determine a quota metric for the interval from the grouped trace based on an uncompleted transaction count wherein the quota metric determines whether an anomaly exists in the trace data, the anomaly comprising a change in the trace data.

The above limitations advantageously enable a metric to describe the quotas for a start trace in a start node queue and end trace in an end node queue of trace data for anomaly detection. The limitations modify the start node queue and the end node queue to result in a grouped trace. There is also a calculation for the quota and detecting the abnormal status of asynchronous transaction. The above limitations advantageously enable improvements to the computer to detect anomalies in the execution of processes and to enable more efficient error correction. Additionally, the limitations advantageously enable improvements to the use of computer resources such as an improvement in the efficient use of memory and a reduction in computer data storage usage since trace data is grouped into a grouped trace in the data store.

The term “trace” as used herein, and without implying any limitation thereto, may refer to a process of capturing and recording information about the execution of a software program or performance of a computer hardware and/or device.

The term “anomaly” as used herein, and without implying any limitation thereto, may refer to unusual or unexpected patterns in data that deviate or change significantly from the norm, often indicating errors, fraud, or other types of unusual events.

The term “provision” as used herein, and without implying any limitation thereto, may refer to process of creating and setting up computing infrastructure, and includes the steps required to manage user and system access to various computing resources.

The term “quota” as used herein, and without implying any limitation thereto, may refer to a limit placed on the amount of computer resources a user or process can consume, such as disk space or application programming interface (API) calls, to prevent overuse and ensure system stability and/or fairness for all users.

The term “node” as used herein, and without implying any limitation thereto, may refer to a unique identifiable and addressable resource in a computer system that a user and/or can perceive as functionally whole.

The term “modify” as used herein, and without implying any limitation thereto, may refer to adjusting, transforming and/or updating data and/or a data structure.

Example 2: The limitations of Example 1, where the uncompleted transaction count comprises a difference of a sum of a start node queue depth of a current interval and a sum of unfinished transaction instances of a previous interval and an end node queue depth of a current interval.

The above limitations advantageously enable an anomaly detection system to determine a quota metric for the interval from the grouped trace enabling improvements to the use of a data store and/or computer resources to determine the quota metric. Additionally, the limitations realize the benefits described with respect to Example 1.

Example 3: The limitations of Example 2, further comprising comparing the quota metric of the interval and a quota metric of the previous interval to determine whether the comparing exceeds an anomaly threshold.

The above limitations advantageously enable determining whether the comparing exceeds an anomaly threshold using an improved comparison of a quota metric of an interval and a quota metric of a previous interval. Additionally, the limitations realize the benefits described with respect to Examples 1-2.

Example 4: The limitations of Example 1, where the grouped trace comprises, the start trace in the start node queue and the end trace in the end node queue, the start trace and the end trace related at least by a transaction identifier.

The above limitations advantageously enable an improved grouped trace based on the start trace and the end trace related at least by a transaction identifier. Additionally, the limitations realize the benefits described with respect to Examples 1-3.

Example 5: The limitations of Example 1, where initializing a trace of a transaction comprises setting a latest start trace in the start point queue as a start trace of a next interval.

The above limitations advantageously enable initializing a trace of a transaction using an improved method of setting a latest start trace in the start point queue as a start trace of a next interval. Additionally, the limitations realize the benefits described with respect to Examples 1-4.

The term “transaction” as used herein, and without implying any limitation thereto, may refer to a transaction is a set of related tasks treated as a single action, forming a logical unit of work. A transaction may comprise sub-transactions which may span multiple processes and/or nodes.

Example 6: The limitations of Example 1, where the start trace is flushed from the start node queue and the end trace is flushed from the end node queue if a condition is met wherein the condition is determined at an interval end.

The above limitations advantageously enable flushing the start node queue and the end node queue for improved computer resource management. Additionally, the limitations realize the benefits described with respect to Examples 1-5.

The term “flushed” as used herein, and without implying any limitation thereto, may refer to the process of clearing or emptying a queue of its contents, where a queue is a data structure that may follow the First-In, First-Out (FIFO) principle. Flushing may also free up computer memory used by the data structure.

Example 7: The limitations of Example 1, where the anomaly detection system traces a transaction that is asynchronously performed by a start node and an end node of a tracked system.

The above limitations advantageously enable anomaly detection of asynchronous performance of transactions performed by a tracked system through improved and performance and efficient use of computer processing and memory resources. Additionally, the limitations realize the benefits described with respect to Examples 1-6.

The term “asynchronously” as used herein, and without implying any limitation thereto, may refer to a transaction comprising a task that will not wait for a response from a previous task before execution. The term may refer to transactions that may take different execution paths depending on different business goals and use cases. The term may refer to a transaction comprising a task that does not return a failure response such as in a silent fail.

Example 8: A computer program product comprising one or more computer readable storage media, and program instructions collectively stored on the one or more computer readable storage media, the program instructions executable by a processor to cause the processor to perform the method according to any of Examples 1-7. The computer program product of Example 8 realizes the benefits described with respect to Examples 1-7. The computer program product of Example 8 can advantageously be implemented into a variety of computer program products.

Example 9: A computer system comprising a processor and one or more computer readable storage media, and program instructions collectively stored on the one or more computer readable storage media, the program instructions executable by the processor to cause the processor to perform the method according to any of Examples 1-7. The computer system of Example 9 realizes the benefits described with respect to Examples 1-7. The computer system of Example 9 can advantageously be implemented into a variety of computer devices.

Example 10: A computer-implemented method that comprises receiving trace data by a receiving interface of an anomaly detection system, wherein the trace data is queued in a start node queue and an end node queue. The method further comprises issuing an instruction via an interface of the anomaly detection system, the instruction executing to provision a data store comprising the start node queue and the end node queue. The method further comprises executing a modifying instruction to modify a start trace of the start node queue and an end trace of the end node queue to result in a grouped trace for an interval, the grouped trace grouped by a relationship between the start trace and the end trace. The method further comprises executing a quota metric instruction to determine a quota metric for the interval from the grouped trace based on an uncompleted transaction count wherein the quota metric determines whether an anomaly exists in the trace data, the anomaly comprising a change in the trace data. The method further comprises where the uncompleted transaction count comprises a difference of a sum of a start node queue depth of a current interval and a sum of unfinished transaction instances of a previous interval, and an end node queue depth. The method further comprises wherein the grouped trace comprises the start trace in the start node queue and the end trace in the end node queue, the start trace and the end trace related at least by a transaction identifier.

The above limitations realize the technical benefits described with respect to Examples 1-7.

Aspects of the present disclosure can be implemented in a variety of technical use cases. The following use cases are merely exemplary and are not intended to limit the scope of the disclosure.

In one example use case, an anomaly detection system receives trace data of a financial transaction system that the anomaly detection system is tracking by an input at a receiving interface. The start trace data from a start node of the financial transaction system is queued in a start trace queue and an end trace data from an end node are queued in an end trace queue. The anomaly detection system issues a provision instruction via an interface of the anomaly detection system, the instruction executing to provision a data store comprising the start node queue and the end node queue. The anomaly detection system executes a modifying instruction to modify a start trace of the start node queue and an end trace of the end node queue to result in a grouped trace for an interval, the grouped trace grouped by a transaction identifier between the start trace and the end trace. The anomaly detection system executes a quota metric instruction to determine a quota metric for the interval from the grouped trace based on an uncompleted transaction count wherein the quota metric determines whether an anomaly exists in the trace data.

The present disclosure provides for a method, a machine-readable medium, and a system for Anomaly Detection of Asynchronous Transactions.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

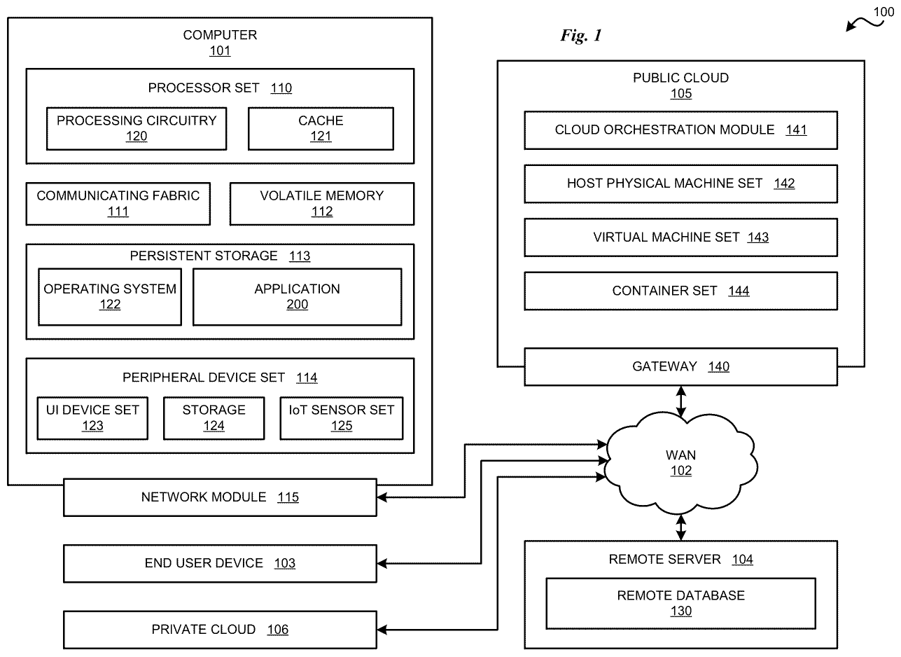

With reference to FIG. 1, this figure depicts a block diagram of a computing environment 100. Data center environment 100 contains an example of an environment for the execution of at least some of the computer code involved in performing the inventive methods, such as Application 200 that provides Anomaly Detection of Asynchronous Transactions. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made. Available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of Application Programming Interfaces (API). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

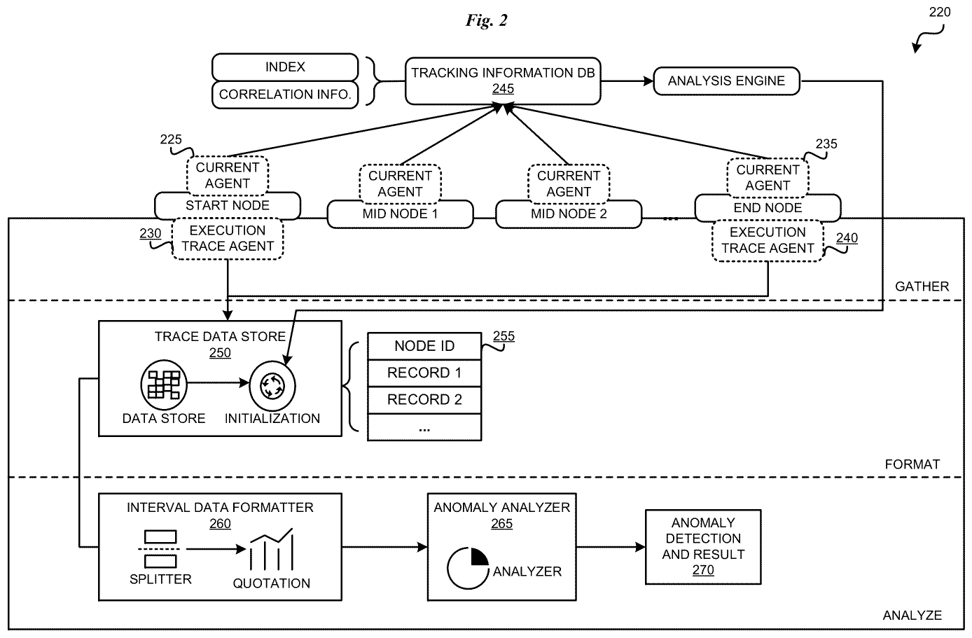

FIG. 2 depicts a diagram of an anomaly monitoring system determining whether an anomaly exists in the trace data in an environment in accordance with an illustrative embodiment. In a particular embodiment, the components of diagram 220 show aspects of the Application 200 of FIG. 1.

In the illustrated embodiment, a current agent 225 captures trace data from the start node mid nodes and an end node 235. For example, end-to-end distributed tracing platforms begin collecting data the moment that a request is initiated, such as when a user submits a form on a website. This triggers the creation of a unique trace ID and an initial span—called the parent span—in the tracing platform. A trace represents the entire execution path of the request, and each span in the trace represents a single unit of work during that journey, such as an API call or database query. Whenever the request enters a service, a top-level child span is created. If the request made multiple commands or queries within the same service, the top-level child span may act as a parent to additional child spans nested beneath it. The distributed tracing platform encodes each child span with the original trace ID and a unique span ID, duration and error data, and relevant metadata, such as customer ID or location.

When processing a transaction, an application may take several actions. These actions are represented as spans or tasks in distributed tracing. For example, a span might be an API call, user authentication, or enabling storage access. If a single request results in several actions, the initial (or parent) span may branch into several child spans. These nested layers of parent and child spans form a continuous logical representation of steps taken to accomplish the service request.

The distributed tracing system assigns a unique ID to every request in order to track it. Each span inherits the same trace ID from the original request it belongs to. Spans are also tagged with a unique span ID that helps the tracing system consolidate the metadata, logs, and metrics it collects.

As each span passes through different microservices, it appends metrics that provide developers with deep and precise insights into the software behavior. Metrics such as error rate, timestamp, response time, and other metadata may be collected with the spans.

Anomaly detection may track common metrics, such as the following: CPU metrics like CPU usage and memory demands. This ensures an application is getting the compute resources it requires to operate adequately; response times are significant for enterprises, as your users expect to be able to access services without delay. The anomaly detection system may measure against an acceptable baseline performance for response times and raise an alert if response times fall below the threshold; trace and monitor applications to record and report error rates. An example of an error would be when a web inquiry times out, or a database query fails. The tracing of transactions provides an accurate picture of single transactions carried out in an application. Information captured in transaction tracing includes available function calls, external calls, and database calls. For example, anomaly detection system may raise an alert to unexpected increases in requests, large numbers of requests from the same user, or unusually low requests; Uptime is critically important for enterprises providing online services. Many service level agreements (SLAs) only allow a percentage point of downtime across predetermined periods.

An execution trace agent for a start node 230 and an execution trace agent for an end node 240 of an anomaly detection system receive trace data through an input at a receiving interface of a respective execution trace agent. In embodiments, the receiving interface provides an interface between an execution trace agent and a current agent 225 and 235, and the trace data is queued in a start trace queue and an end trace queue. The current agents may be known tracing agents that send data to a tracking information database (DB) 245. In some embodiments, the receiving interface may be a software or a hardware interface. For example, an interface provides components that enable users and applications to access, control, and transfer trace data across networks including but not limited to application programming interface (API), internet protocol interfaces, and system interfaces using hardware such as sockets, buses, and/or input/output devices.

In embodiments, the execution trace agent communicates and issues an instruction via an interface of the anomaly detection system to provision a trace data store 250 comprising a data store and an initialization to initialize a start trace queue and an end trace queue, shown for instance by 255. An interval data formatter 260 may execute a modifying instruction to modify a start trace in the start trace queue and an end trace in the end trace queue to result in a grouped trace for an interval. An anomaly analyzer 265 executes a quota metric instruction to determine a quota metric for the interval from the grouped trace based on a count of a start trace queue size and an uncompleted transaction of a previous interval. An anomaly detection and result 270 detects whether an anomaly exists in the trace data.

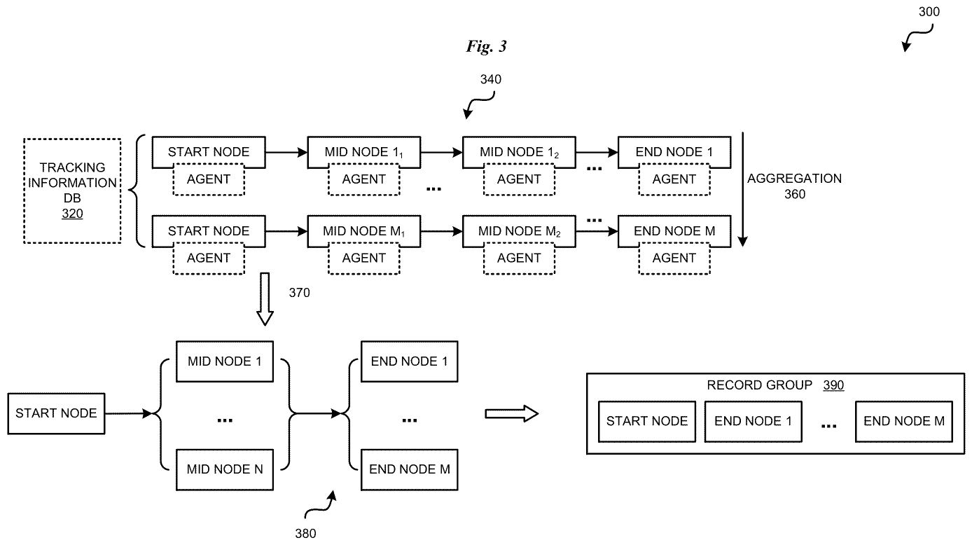

FIG. 3 depicts a diagram of receiving a start trace in the start node queue and an end trace in the end node queue in an environment in accordance with an illustrative embodiment. In a particular embodiment, the components of diagram 300 show aspects of the Application 200 of FIG. 1.

In the illustrated embodiment, trace data from the start nodes, middle (mid) nodes, and end nodes of a tracked system 340 are sent to the tracking information database (DB) 320, and this trace data is aggregated 360. In an embodiment, trace data 370 comprising a start trace from the start node and aggregated mid nodes and end nodes is aggregated. Aggregate the start node and all its end nodes 380. In some embodiments, the mid node trace information may be consolidated into an end node. The information may then be stored in a data store to form the structure, after this, all the execution trace in the same aggregated group will be stored together 390.

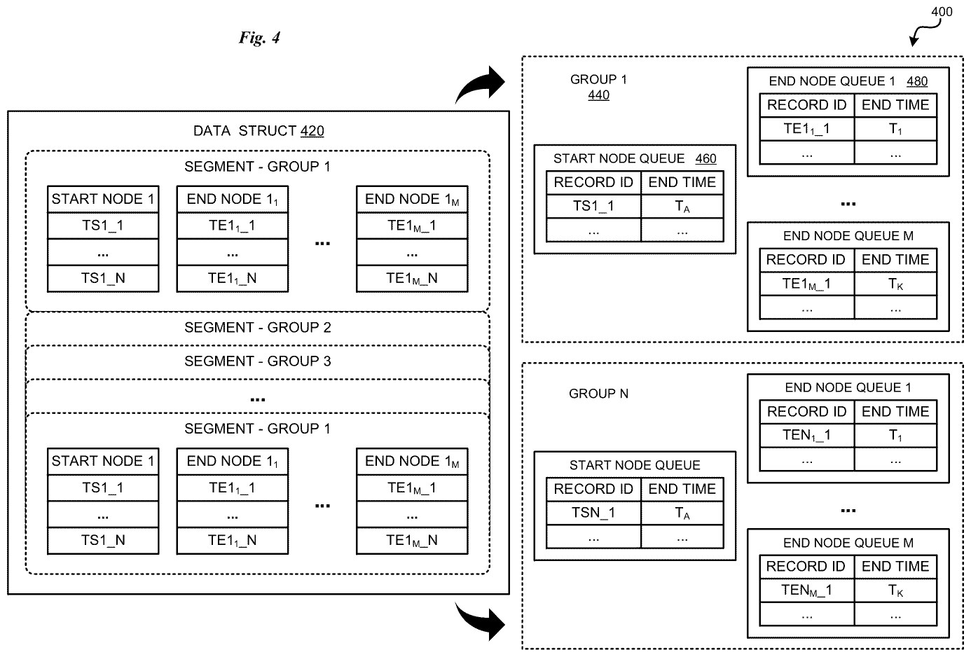

FIG. 4 depicts a diagram of a data structure of a start node queue and an end node queue in a data store in an environment in accordance with an illustrative embodiment. In a particular embodiment, the components of diagram 400 show aspects of the Application 200 of FIG. 1.

In the illustrated embodiment, a data structure 420 comprises trace data of an aggregated start node and all its end nodes. For example, trace data for the aggregated start node and all its end nodes may comprise trace data for all the paths to perform a transaction that may initiate at a start node and perform operations at multiple end nodes. In embodiments, a start node and an end node generate trace data comprising a start trace and an end trace, respectively. In some embodiments, a start trace, and an end trace may be a data structure comprising a transaction record identifier (ID) and an end time value.

In some embodiments, a modifying instruction is executed to modify the start node queue and the end node queue to result in a grouped trace, for example Group 1, 440, for an interval, grouped by a start trace in a start node queue 460 and an end trace in an end node queue 480. For example, an attempt may be made to modify the start node queue and the end node queue by grouping a start trace and an end trace by transaction ID. In another instance, during an operation of an asynchronous transaction, some of the sub-transaction or tasks will not wait until the response after the request is made. The start transaction usually issues the starting point of the transaction and ends immediately. Another transaction will be used for the response. In such an instance, the system may use techniques such as matching by transaction ID, for sub-transactions that have matching transaction IDs, and/or using historical data to match the start trace and end trace for the entire transaction. For example, historical data may match the start trace and end trace for the entire transaction based on the historical path that a particular transaction takes through nodes of the tracked system.

In another embodiment, the grouped trace is stored as a segment of the data store. A segment is a logical unit of storage, larger than an extent, that can hold data structures like tables, indexes, or partitions, and all segments are stored within a tablespace.

In embodiments, the start trace is flushed from the start node queue and the end trace is flushed from the end node queue if a condition is met where the condition is determined at an interval end. For example, flushing clears or empties a start node queue and an end node queue of its contents, in the event of a condition including but not limited to a successful grouping of a transaction, the end of an interval, or a system event such as memory management.

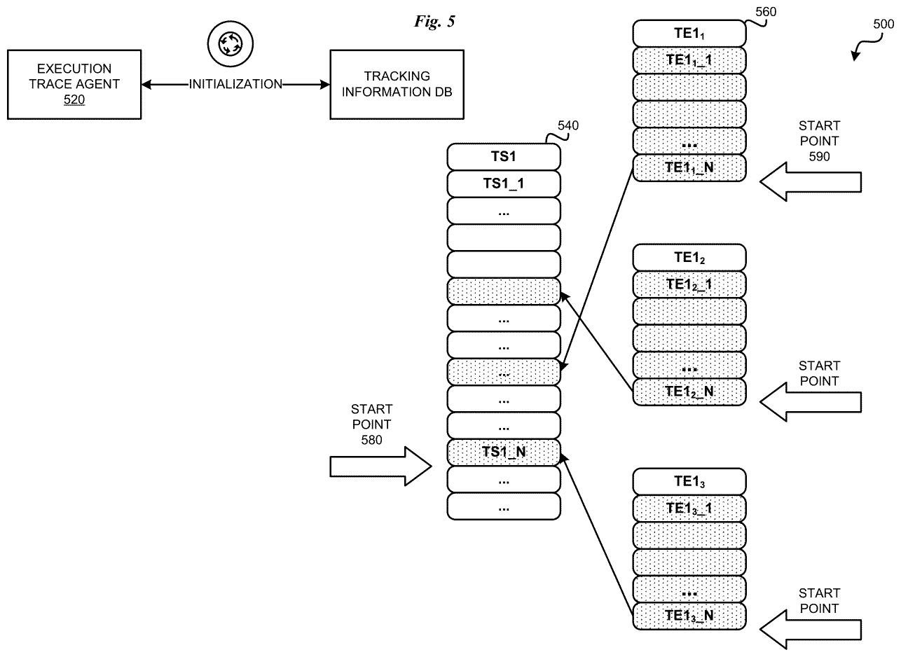

FIG. 5 depicts a diagram of initializing a start trace in a start node queue and an end trace in an end node queue an environment in accordance with an illustrative embodiment. In a particular embodiment, the components of diagram 500 show aspects of the Application 200 of FIG. 1.

In the illustrated embodiment, the initilizer of execution trace agent 520 will query the Tracking information DB to retrieve related start trace from a start node queue 540 for every end trace in an end node queue 560. Then the initializer will compare the end time in the start node queue. The initializer will set the latest start point 580 as the start trace of a next interval. The initializer will flush out the start trace and end traces from the start node queue and end node queues respectively. The execution trace agent will start the trace of a next interval from the latest start point 580 and will set an end trace of each end node queue as a start point 590 of an end trace of a next interval for end node queues.

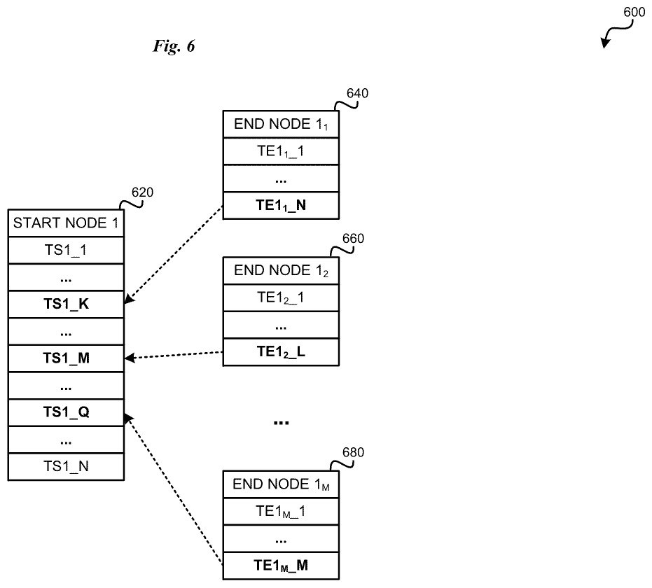

FIG. 6 depicts a diagram of determining a quota metric for an interval from the grouped trace in an environment in accordance with an illustrative embodiment. In a particular embodiment, the components of diagram 600 show aspects of the Application 200 of FIG. 1.

In the illustrated embodiment, when an interval ends, the system executes instructions to check the latest transaction instance in a start node queue, for example, TS1ₘ_n 620, and in each end node queue, for example, TE1₁_n 640, TE1₂_l 660 and TE1ₘ_M 680. Identify the related transaction instances from start node queue and select the latest one. For example, TS1_q. Calculate the number of unfinished transaction instances in a start node queue, which equals the difference of the sum of start node queue of current interval and unfinished transaction instances of previous interval and all end node queue depth of the current interval (q-1- . . . -m). For example, suppose there are N unfinished transaction instances in previous interval, then:

$$count ( unfinished transaction instances in a start node queue ) = q + N - n - 1 - … - m$$

In an embodiment, determine the quota metric of all the paths by calculating the percentage of each end node and the start node and the percentage of unfinished transaction instances and the start node. For example, a quota metric

$$quota = [ n / ( q + N ) , 1 / ( q + N ) , m / ( q + N ) , \\ count ( unfinished transaction instances ) / ( q + N ) ]$$

In an embodiment, the system compares the quota metric of the interval and a quota metric of the previous interval, for example, by calculating the quota difference of the two intervals. The quota comparison may determine the status of asynchronous transaction execution status and/or whether the comparing exceeds an anomaly threshold. In periodic transaction system, if the difference reaches the threshold, the alert should be reported.

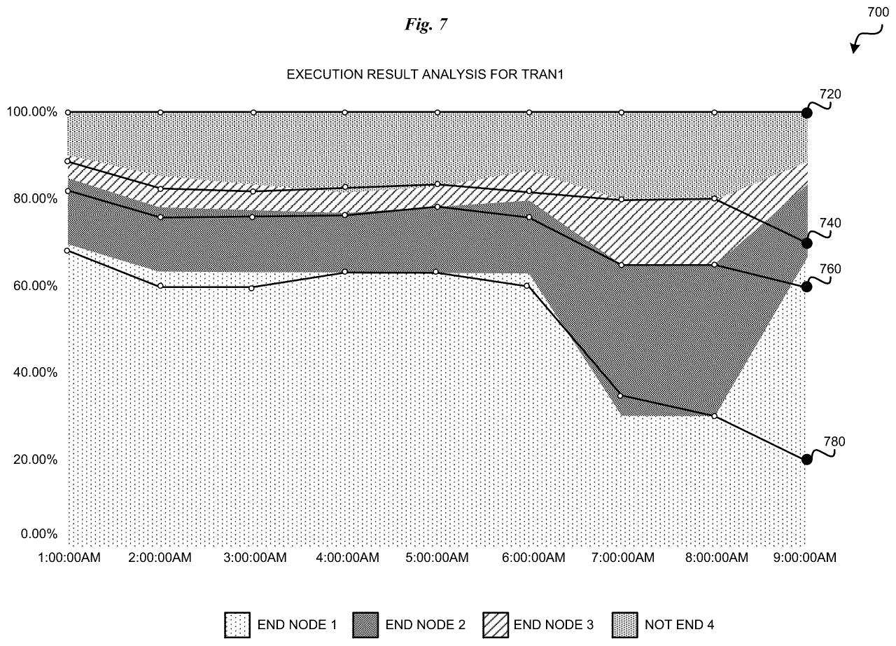

FIG. 7 depicts a graph of trace trends to detect an anomaly in an environment in accordance with an illustrative embodiment. In a particular embodiment, the components of diagram 700 show aspects of the Application 200 of FIG. 1.

In the illustrated embodiment, the x-axis of the graph is the time, and the y-axis is the percent variation. The trace data from a baseline 720, end node 3 740, end node 2 760 and end node 1 780 are plotted. In some embodiments, the anomaly analyzer will check the metric of each interval to form a trend curve and baseline. Based on the trace lines and baseline, a threshold of an anomaly transaction may be defined. When anomaly occurs, there will be an alert from the analyzer.

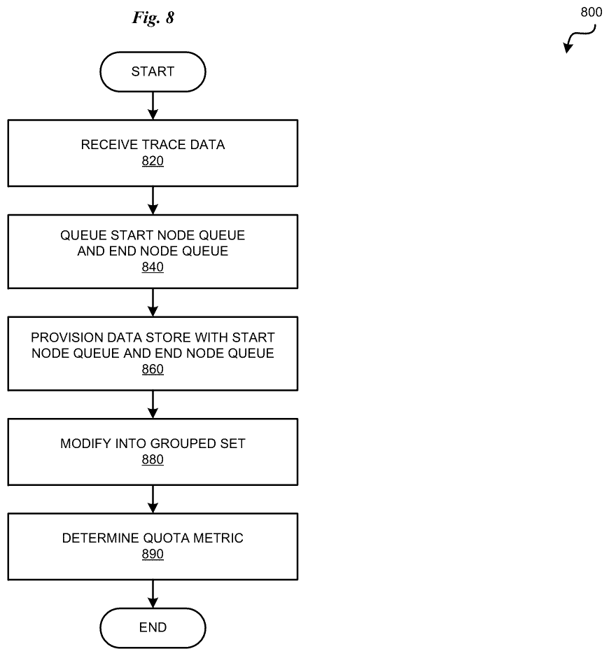

FIG. 8 depicts a flow chart of detecting an anomaly by an anomaly detection system in an environment in accordance with an illustrative embodiment. In a particular embodiment, the components of diagram 800 show aspects of the Application 200 of FIG. 1.

In the illustrated embodiment, at step 820, the anomaly detection system receives trace data by an input at a receiving interface. For example, an execution trace agent interfaces with a current agent that is deployed at a node of a target system over an interface such as a socket and/or IO interface to receive trace data from a start/end node of a monitored system. In such an example, the receiving interface may detect a data packet indicating that trace data from a start node and/or end node is arriving. A socket and/or IO connection is opened and the data is received. At step 840, trace data from a start node is queued in a start node queue and trace data from an end node is queued an end node queue, via the respective interfaces.

In an embodiment, at step 860, the anomaly detection system issues a provision instruction via an interface to provision a data store comprising the start node queue and the end node queue. For example, the provisioning process creates and sets up the data store infrastructure, and includes the steps required to manage user and system access to various resources.

At step 880, the anomaly detection system executes a modifying instruction to modify a start trace in the start node queue and an end trace in the end node queue to result in a grouped trace. For example, the modifying instruction is executed to modify the start node queue and the end node queue to result in a grouped trace for an interval grouped by a relationship between the start trace and the end trace. An interval, for instance, may be user or system defined. In another instance, an interval may be shorter than or longer than the time taken for the tracked system to complete a transaction.

In another example, the grouped trace comprises the start trace in the start trace queue and the end trace in the start trace queue related at least by a transaction identifier. In such instances, executing the modifying instruction may cause the processor to provision a segment of data store memory and assign to the segment memory address pointers to a start trace in a start node queue and an end trace in an end node queue.

At step 890, the anomaly detection system executes a quota metric instruction to determine a quota metric for the interval from the grouped trace. A quota is a limit or restriction on the amount of a specific resource a user or project can consume, such as disk space, API calls, or network bandwidth. The types of quotes may include but are not limited to disk quotas: the amount of disk space a user or group can use; file quotas: the number of files or directories a user or group can create; API rate quotas: the number of requests a user or project can make to a specific API within a given time period; and/or resource quotas: the use of various resources, such as CPU, memory, or network bandwidth.

In an embodiment, a quota metric for an interval is determined from the grouped trace based on an uncompleted transactions count in the start node queue. For instance, the uncompleted transaction count in the start node queue comprises a difference of a sum of a start node queue depth of a current interval and a sum of unfinished transaction instances of a previous interval and an end node queue depth. In another example, a quota metric is determined as a percentage of each end node queue and the start node queue and the percentage of unfinished transaction instances for a particular interval. Calculate the quota metric difference between the current interval and the previous interval. The quota difference to record the status of asynchronous transaction execution status and set threshold for alert. In periodic transaction system, if the difference or change reaches the threshold, the alert should be reported.

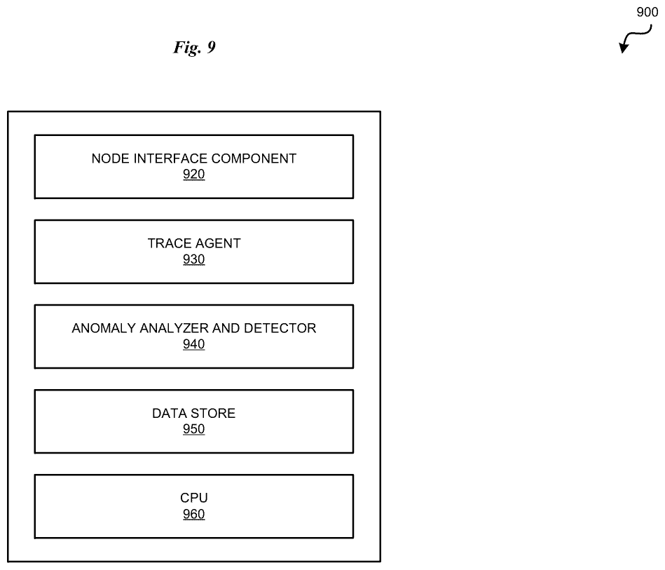

FIG. 9 depicts a system diagram of an anomaly detection system to detect an anomaly in an environment in accordance with an illustrative embodiment. In a particular embodiment, the components of the diagram 900 show aspects of the Application 200 of FIG. 1.

In the illustrated embodiment, the system may comprise a node interface component 920, a trace agent 930, an anomaly analyzer and detector 940, a data store 950, and a central processing unit (CPU) 960. The node interface component 920 may comprise components that enable users and applications to access, control, and transfer trace data across networks including but not limited to application programming interface (API), internet protocol interfaces, and system interfaces using hardware such as sockets, buses, and/or input/output devices.

A trace agent 930 may comprise various input and output interfaces with a monitored system from where tracing data is received and to interface with an execution trace agent. A trace agent for example, may be an application interface across many components of a microservice where the microservices architecture allows multiple technology stacks, decentralized data management, and independent evolution of services in an application. A user transaction can travel hundreds or even thousands of these components to fulfill a single-use case. Trace may also be provided by an external hardware block connected to the core. Trace information may also be stored in an on-chip memory buffer.

A physical data storage device is the underlying technology behind a data store 950. The data store may comprise a data store interface that receives a provision instruction, its execution causing the data store to provision resources such as a start node queue, an end node queue, files, tables, or blocks stored on a device. The device can be local, remote, or in the cloud. Large data stores are typically distributed across multiple physical devices in different geographic locations. Software systems and services abstract the underlying operations of the data store. Different types of data storage devices provide varying degrees of security and redundancy. A solid-state drive (SSD) is a semiconductor technology that allows the writing and reading of data in flash memory chips. Flash storage technology was commercially available in pen drives before becoming an alternative to hard disk drives (HDD). Compared to an HDD, a physical SSD has no moving parts, which means it has faster performance and a longer lifespan. Hybrid storage array is a physical storage setup that consists of an SSD and an HDD. While an SSD offers a low-latency operation, it costs much more per-unit storage than an HDD. Therefore, organizations use a hybrid storage array to balance performance, capacity, and cost. RAID stands for a redundant array of independent disks. It is a technology that keeps the same data in multiple places on an SSD.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
receiving trace data by an input at a receiving interface of an anomaly detection system, wherein the trace data is queued in a start node queue and an end node queue;
issuing a provision instruction via an interface of the anomaly detection system, the provision instruction received by a data store interface, the provision instruction executing to provision a data store comprising the start node queue and the end node queue;
executing a modifying instruction to modify a start trace in the start node queue and an end trace in the end node queue to result in a grouped trace for an interval, the grouped trace grouped by a relationship between the start trace and the end trace; and
executing a quota metric instruction to determine a quota metric for the interval from the grouped trace based on an uncompleted transaction count wherein the quota metric determines whether an anomaly exists in the trace data, the anomaly comprising a change in the trace data.

2. The computer-implemented method of claim 1, wherein determining whether an anomaly exists comprises comparing the quota metric of the interval and a quota metric of a previous interval to determine whether the comparing exceeds an anomaly threshold.

3. The computer-implemented method of claim 1, wherein the uncompleted transaction count comprises a difference between a sum of a start node queue depth of a current interval and a sum of unfinished transaction instances of a previous interval and an end node queue depth of the current interval.

4. The computer-implemented method of claim 1, wherein the grouped trace comprises the start trace in the start node queue and the end trace in the end node queue, the start trace and the end trace related at least by a transaction identifier.

5. The computer-implemented method of claim 1, wherein initializing a trace of a transaction comprises setting a latest start trace in the start node queue as a start trace of a next interval.

6. The computer-implemented method of claim 1, wherein the start trace is flushed from the start node queue and the end trace is flushed from the end node queue if a condition is met wherein the condition is determined at an interval end.

7. The computer-implemented method of claim 1, wherein the anomaly detection system traces a transaction that is asynchronously performed by a start node and an end node of a tracked system.

8. A computer program product comprising one or more computer readable storage media, and program instructions collectively stored on the one or more computer readable storage media, the program instructions executable by a processor to cause the processor to perform operations comprising:
receiving trace data by an input at a receiving interface of an anomaly detection system, wherein the trace data is queued in a start node queue and an end node queue;
issuing a provision instruction via an interface of the anomaly detection system, the provision instruction received by a data store interface, the provision instruction executing to provision a data store comprising the start node queue and the end node queue;
executing a modifying instruction to modify a start trace in the start node queue and an end trace in the end node queue to result in a grouped trace for an interval, the grouped trace grouped by a relationship between the start trace and the end trace; and
executing a quota metric instruction to determine a quota metric for the interval from the grouped trace based on an uncompleted transaction count wherein the quota metric determines whether an anomaly exists in the trace data, the anomaly comprising a change in the trace data.

9. The computer program product of claim 8, wherein determining whether an anomaly exists comprises comparing the quota metric of the interval and a quota metric of a previous interval to determine whether the comparing exceeds an anomaly threshold.

10. The computer program product of claim 8, wherein the uncompleted transaction count comprises a difference between a sum of a start node queue depth of a current interval and a sum of unfinished transaction instances of a previous interval and an end node queue depth of the current interval.

11. The computer program product of claim 8, wherein the grouped trace comprises the start trace in the start node queue and the end trace in the end node queue, the start trace and the end trace related at least by a transaction identifier.

12. The computer program product of claim 8, wherein initializing a trace of a transaction comprises setting a latest start trace in the start node queue as a start trace of a next interval.

13. The computer program product of claim 8, wherein the start trace is flushed from the start node queue and the end trace is flushed from the end node queue if a condition is met wherein the condition is determined at an interval end.

14. The computer program product of claim 8, wherein the anomaly detection system traces a transaction that is asynchronously performed by a start node and an end node of a tracked system.

15. A computer system comprising a processor and one or more computer readable storage media, and program instructions collectively stored on the one or more computer readable storage media, the program instructions executable by the processor to cause the processor to perform operations comprising:
receiving trace data by an input at a receiving interface of an anomaly detection system, wherein the trace data is queued in a start node queue and an end node queue;
issuing a provision instruction via an interface of the anomaly detection system, the provision instruction received by a data store interface, the provision instruction executing to provision a data store comprising the start node queue and the end node queue;
executing a modifying instruction to modify a start trace in the start node queue and an end trace in the end node queue to result in a grouped trace for an interval, the grouped trace grouped by a relationship between the start trace and the end trace; and
executing a quota metric instruction to determine a quota metric for the interval from the grouped trace based on an uncompleted transaction count wherein the quota metric determines whether an anomaly exists in the trace data, the anomaly comprising a change in the trace data.

16. The computer system of claim 15, wherein determining whether an anomaly exists comprises comparing the quota metric of the interval and a quota metric of a previous interval to determine whether the comparing exceeds an anomaly threshold.

17. The computer system of claim 16, wherein the uncompleted transaction count comprises a difference between a sum of a start node queue depth of a current interval and a sum of unfinished transaction instances of a previous interval and an end node queue depth of the current interval.

18. The computer system of claim 15, wherein the grouped trace comprises the start trace in the start node queue and the end trace in the end node queue, the start trace and the end trace related at least by a transaction identifier.

19. The computer system of claim 15, wherein initializing a trace of a transaction comprises setting a latest start trace in the start node queue as a start trace of a next interval.

20. The computer system of claim 15, wherein the start trace is flushed from the start node queue and the end trace is flushed from the end node queue if a condition is met wherein the condition is determined at an interval end.
